(19) United States
(12) Patent Application Publication
(10) Pub. No.: US 2015/0329781 A1
(43) Pub. Date: Nov. 19, 2015

(54) LIQUID CRYSTAL ALIGNMENT AGENT, LIQUID CRYSTAL ALIGNMENT FILM, AND LIQUID CRYSTAL DISPLAY ELEMENT

(71) Applicant: Chi Mei Corporation, Tainan City (TW)

(72) Inventors: Wei-Lun Chang, Yunlin County (TW); Li-Tao Hsu, Kaohsiung City (TW)

(21) Appl. No.: 14/711,793

(22) Filed: May 14, 2015

(30) Foreign Application Priority Data
May 15, 2014 (TW) 103117173

(51) Int. Cl. C09K 19/56; C08L 79/08

(52) U.S. Cl. CPC C09K 19/56; C08L 79/08

(57) ABSTRACT

A liquid crystal alignment agent having both good ultraviolet reliability and low ion density, a liquid crystal alignment film formed by the liquid crystal alignment agent, and a liquid crystal display element having the liquid crystal alignment film are provided. The liquid crystal alignment agent includes a polymer composition (A) and a solvent (B). The polymer composition (A) is obtained by reacting a mixture. The mixture includes a carboxylic anhydride component (a) and a diamine component (b). The carboxylic anhydride component (a) includes a tetracarboxylic dianhydride compound (a-1) and a tricarboxylic anhydride compound (a-2). The diamine component (b) includes a diamine compound (b-1) represented by formula (I).

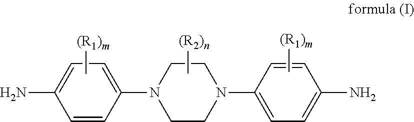

### CROSS-REFERENCE TO RELATED APPLICATION

This application claims the priority benefit of Taiwan application serial no. 103117173, filed on May 15, 2014. The entirety of the above-mentioned patent application is hereby incorporated by reference herein and made a part of this specification.

### BACKGROUND OF THE INVENTION

1. Field of the Invention

The invention relates to a liquid crystal alignment agent, a liquid crystal alignment film, and a liquid crystal display element. More particularly, the invention relates to a liquid crystal alignment agent having good ultraviolet reliability and low ion density, a liquid crystal alignment film formed by the liquid crystal alignment agent, and a liquid crystal display element having the liquid crystal alignment film.

2. Description of Related Art

In recent years, various industries have been actively committed to the development of a novel liquid crystal display element. Using a horizontal electric field-type liquid crystal display element as an example, two electrodes are disposed on one side of a pair of opposing substrates in the horizontal electric field-type liquid crystal display element, wherein the electrodes are disposed in a pectinate shape. The electrodes can generate an electric field parallel to the substrates, thereby controlling the liquid crystal molecules. The device is generally referred to as an in-plane switching (IPS)-type liquid crystal display element. It should be mentioned that, although the IPS liquid crystal display element is popular due to excellent wide viewing angle characteristics, the issue of image sticking still occurs in the IPS-type liquid crystal display element due to excessive ion density.

Japanese Patent Laid-Open Publication No. 2009-175684 discloses a liquid crystal alignment film having low ion density and a diamine compound containing a piperazine structure used to prepare a liquid crystal alignment film. The liquid crystal alignment film made by the diamine compound containing a piperazine structure can improve the known issue of reduced display quality of the liquid crystal display caused by excessive ion density. However, the liquid crystal alignment film has the issue of poor ultraviolet reliability. Specifically, after the liquid crystal alignment film is irradiated by ultraviolet for a period of time, the situation of significantly reduced voltage holding ratio occurs, thereby causing issues such as reduced contrast of the liquid crystal display.

Therefore, how to provide a liquid crystal alignment agent having both good ultraviolet reliability and low ion density such that high voltage holding ratio is still maintained after prolonged ultraviolet irradiation when the liquid crystal alignment film formed thereby is used in a liquid crystal display element is a current issue those skilled in the art urgently need to solve.

### SUMMARY OF THE INVENTION

Accordingly, the invention provides a liquid crystal alignment agent having good ultraviolet reliability and low ion density, a liquid crystal alignment film formed by the liquid crystal alignment agent, and a liquid crystal display element having the liquid crystal alignment film.

The invention provides a liquid crystal alignment agent including a polymer composition (A) and a solvent (B). The polymer composition (A) is obtained by reacting a mixture, wherein the mixture includes a carboxylic anhydride component (a) and a diamine component (b). The carboxylic anhydride component (a) includes a tetracarboxylic dianhydride compound (a-1) and a tricarboxylic anhydride compound (a-2). The diamine component (b) includes a diamine compound (b-1) represented by formula (I).

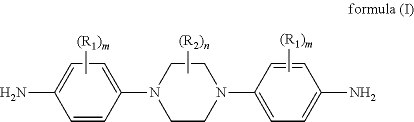

In formula (I), R₁ each independently represents a hydrogen atom, a C₁ to C₁₀ alkyl group, a C₁ to C₁₀ alkoxy group, an acetamido group, a fluorine atom, a chlorine atom, or a bromine atom; R₂ each independently represents a C₁ to C₃ alkyl group; m each independently represents an integer of 0 to 3; and n represents an integer of 0 to 4.

In an embodiment of the invention, in formula (I), R₁ each independently represents a hydrogen atom, a C₁ to C₁₀ alkyl group, a C₁ to C₁₀ alkoxy group, or an acetamido group (CH₃CONH—).

In an embodiment of the invention, the tricarboxylic anhydride compound (a-2) includes a cyclic tricarboxylic anhydride compound.

In an embodiment of the invention, based on a total number of moles of 100 moles of the carboxylic anhydride component (a), the usage amount of the tricarboxylic anhydride compound (a-2) is 1 mole to 50 moles.

In an embodiment of the invention, based on a total number of moles of 100 moles of the diamine component (b), the usage amount of the diamine compound (b-1) is 1 mole to 80 moles.

In an embodiment of the invention, the molar ratio (a-2)/(b-1) of the tricarboxylic anhydride compound (a-2) and the diamine compound (b-1) is 0.1 to 5.

In an embodiment of the invention, the liquid crystal alignment agent further includes a compound (C) having at least two epoxy groups.

The invention further provides a liquid crystal alignment film. The liquid crystal alignment film is formed by the above liquid crystal alignment agent.

The invention further provides a liquid crystal display element. The liquid crystal display element includes the above liquid crystal alignment film.

Based on the above, the ultraviolet reliability of the liquid crystal alignment agent of the invention is good and the ion density thereof is low. Therefore, the liquid crystal alignment agent of the invention is suitable for forming a liquid crystal alignment film, and the liquid crystal alignment film is suitable for a liquid crystal display element.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a liquid crystal display element according to an embodiment of the invention.

### DESCRIPTION OF THE EMBODIMENTS

### Liquid Crystal Alignment Agent

The invention provides a liquid crystal alignment agent including a polymer composition (A) and a solvent (B). Moreover, if needed, the liquid crystal alignment agent can further include a compound (C) having at least two epoxy groups, an additive (D), or a combination of the two.

In the following, each component of the liquid crystal alignment agent of the invention is described in detail.

It should be mentioned that, in the following, (meth)acrylic acid represents acrylic acid and/or methacrylic acid, and (meth)acrylate represents acrylate and/or methacrylate. Similarly, (meth)acryloyl group represents acryloyl group and/or methacryloyl group.

### Polymer Composition (A)

The polymer composition (A) is obtained by reacting a mixture. The mixture includes a carboxylic anhydride component (a) and a diamine component (b).

### Carboxylic Anhydride Component (a)

The carboxylic anhydride component (a) includes a tetracarboxylic dianhydride compound (a-1) and a tricarboxylic anhydride compound (a-2).

Tetracarboxylic Dianhydride Compound (a-1)

The tetracarboxylic dianhydride compound (a-1) includes an aliphatic tetracarboxylic dianhydride compound, an alicyclic tetracarboxylic dianhydride compound, an aromatic tetracarboxylic dianhydride compound, at least one of the tetracarboxylic dianhydride compounds represented by formula (1) to formula (6), or a combination of the compounds.

Specific examples of the aliphatic tetracarboxylic dianhydride compound can include, but are not limited to, ethane tetracarboxylic dianhydride, butane tetracarboxylic dianhydride, or a combination of the compounds.

Specific examples of the alicyclic tetracarboxylic dianhydride compound can include, but are not limited to, 2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,3-dichloro-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexyl tetracarboxylic dianhydride, cis-3,7-dibutyl-cycloheptyl-1,5-diene-1,2,5,6-tetracarboxylic dianhydride, 2,3,5-tricarboxycyclopentylacetic dianhydride, bicyclo[2.2.2]-oct-7-ene-2,3,5,6-tetracarboxylic dianhydride, or a combination of the compounds.

Specific examples of the aromatic tetracarboxylic dianhydride compound can include, but are not limited to, an aromatic tetracarboxylic dianhydride compound such as 3,4-dicarboxy-1,2,3,4-tetrahydronaphthalene-1-succinic dianhydride, pyromellitic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′-4,4′-diphenyl ethane tetracarboxylic dianhydride, 3,3′,4,4′-dimethyl diphenyl silane tetracarboxylic dianhydride, 3,3′,4,4′-tetraphenyl silane tetracarboxylic dianhydride, 1,2,3,4-furan tetracarboxylic dianhydride, 4,4′-bis(3,4-dicarboxy phenoxy)diphenylsulfide dianhydride, 4,4′-bis(3,4-dicarboxy phenoxy)diphenylsulfone dianhydride, 4,4′-bis(3,4-dicarboxy phenoxy)diphenylpropane dianhydride, 3,3′,4,4′-perfluoroisopropylidene diphenyl dicarboxylic dianhydride, 3,3′,4,4′-diphenyl tetracarboxylic dianhydride, bis(phthalic acid)phenyl phosphine oxide dianhydride, p-phenylene-bis(triphenylphthalic acid) dianhydride, m-phenylene-bis(triphenylphthalic acid) dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofuran tetracarboxylic dianhydride, 1,3,3a,4,5,9b-hexahydro-5-(tetrahydro-2,5-dioxo-3-furanyl) naphtho[1,2-c]furan-1,3-dione, 1,3,3a,4,5,9b-hexahydro-5-methyl-5-(tetrahydro-2,5-dioxo-3-furanyl)naphtho[1,2-c]furan-1,3-dione, 1,3,3a,4,5,9b-hexahydro-5-ethyl-5-(tetrahydro-2,5-dioxo-3-furanyl)naphtho[1,2-c]furan-1,3-dione, 1,3,3a,4,5,9b-hexahydro-7-methyl-5-(tetrahydro-2,5-dioxo-3-furanyl)naphtho[1,2-c]furan-1,3-dione, 1,3,3a,4,5,9b-hexahydro-7-ethyl-5-(tetrahydro-2,5-dioxo-3-furanyl)naphtho[1,2-c]furan-1,3-dione, 1,3,3a,4,5,9b-hexahydro-8-methyl-5-(tetrahydro-2,5-dioxo-3-furanyl)naphtho[1,2-c]furan-1,3-dione, 1,3,3a,4,5,9b-hexahydro-8-ethyl-5-(tetrahydro-2,5-dioxo-3-furanyl)naphtho[1,2-c]furan-1,3-dione, 1,3,3a,4,5,9b-hexahydro-5,8-dimethyl-5-(tetrahydro-2,5-dioxo-3-furanyl)naphtho[1,2-c]furan-1,3-dione, 5-(2,5-dioxotetrahydrofural)-3-methyl-3-cyclohexene-1,2-dicarboxylic dianhydride, or a combination of the compounds.

The tetracarboxylic dianhydride compounds represented by formula (1) to formula (6) are as shown below.

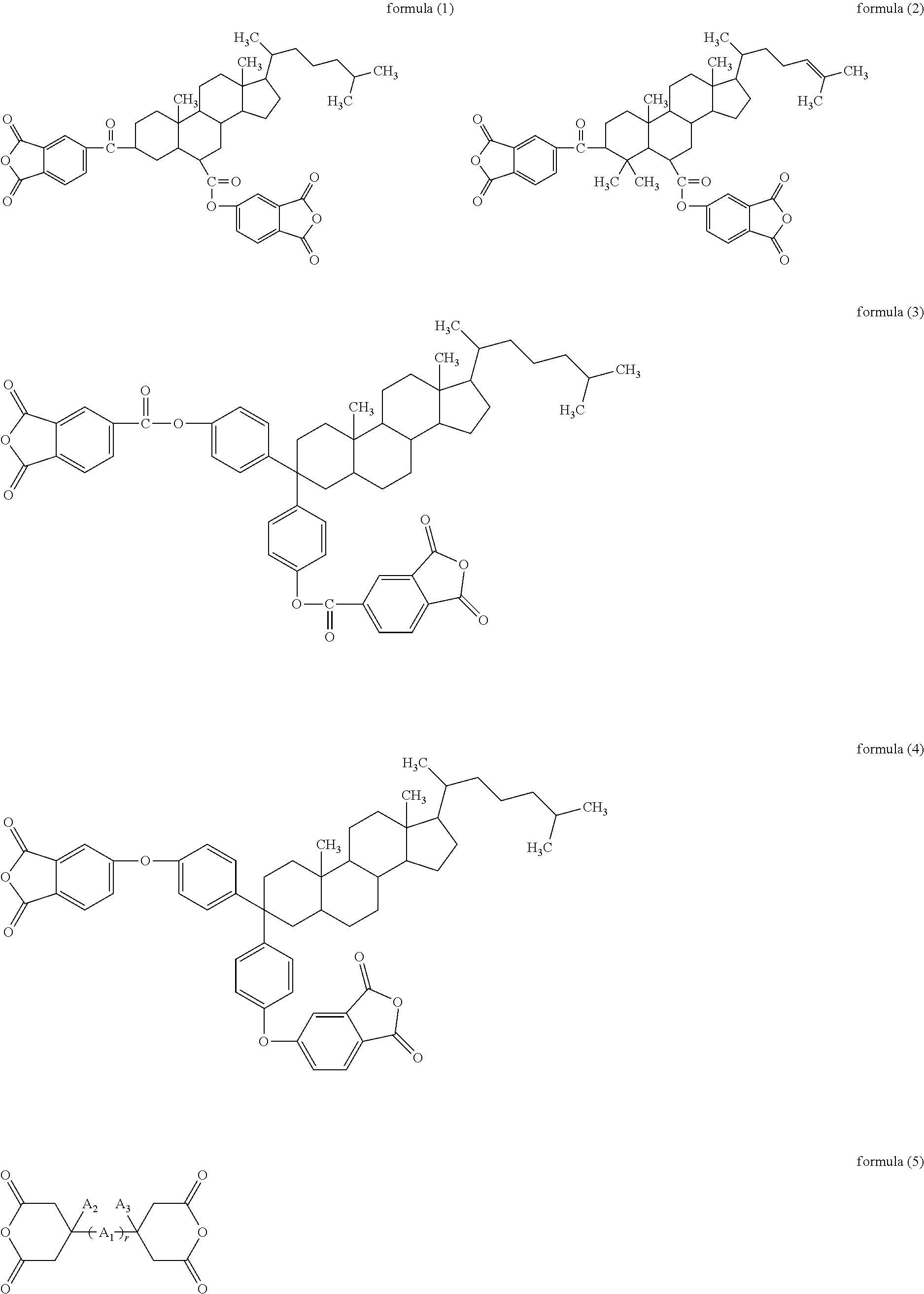

In formula (5), A₁ represents a divalent group containing an aromatic ring; r represents an integer of 1 to 2; and A₂ and A₃ can be the same or different, and can each independently represent a hydrogen atom or an alkyl group. Specific examples of the tetracarboxylic dianhydride compound represented by formula (5) include at least one of the compounds represented by formula (5-1) to formula (5-3).

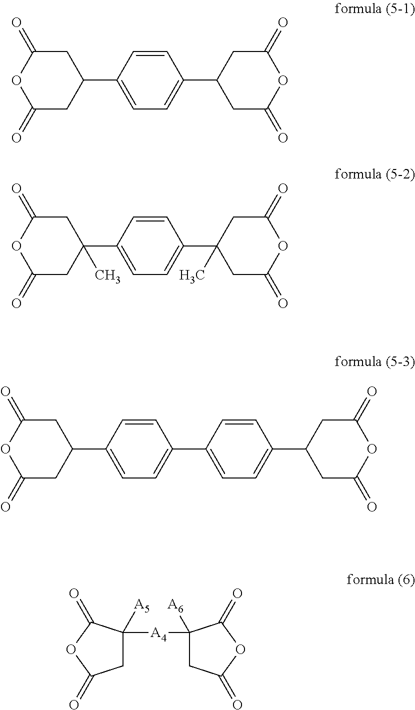

In formula (6), A₄ represents a divalent group containing an aromatic ring; and A₅ and A₆ can be the same or different, and each independently represent a hydrogen atom or an alkyl group. The tetracarboxylic dianhydride compound represented by formula (6) is preferably a compound represented by formula (6-1).

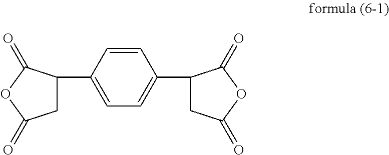 [SMILES: O=C1CC(c2ccc(C3CC(=O)OC3=O)cc2)C(=O)O1]

The tetracarboxylic dianhydride compound (a-1) can be used alone or in multiple combinations.

Based on a total number of moles of 100 moles of the carboxylic anhydride component (a), the usage amount of the tetracarboxylic dianhydride compound (a-1) can be 50 moles to 99 moles, preferably 55 moles to 97 moles, and more preferably 60 moles to 95 moles.

Tricarboxylic Anhydride Compound (a-2)

The tricarboxylic anhydride compound (a-2) can include, for instance, an aliphatic tricarboxylic anhydride compound, an alicyclic tricarboxylic anhydride compound, or an aromatic tricarboxylic anhydride compound.

Specific examples of the aliphatic tricarboxylic anhydride compound can include, but are not limited to, 3-carboxymethyl glutaric anhydride, 1,2,4-butanetricarboxylic-1,2-anhydride, cis-propene-1,2,3-tricarboxylic-1,2-anhydride, or a combination of the compounds.

Specific examples of the alicyclic tricarboxylic anhydride compound can include, but are not limited to, 1,2,3-tricarboxycyclopropane-1,2-anhydride, 1,2,3-tricarboxycyclobutane-1,2-anhydride, 1,3,4-cyclopentane tricarboxylic anhydride, 1,2,4-tricarboxycyclohexane-1,2-anhydride, 1,3,4-tricarboxycyclohexane-3,4-anhydride, 1,3,5-tricarboxycyclohexane-3,5-anhydride, 1,2,3-tricarboxycyclohexane-2,3-anhydride, 6-methyl-4-cyclohexane-1,2,3-tricarboxylic-1,2-anhydride, or norbornane tricarboxylic anhydride.

Specific examples of the aromatic tricarboxylic anhydride compound can include, but are not limited to, trimellitic anhydride, 1,2,3-tricarboxybenzene-1,2-anhydride, 1,2,4-tricarboxybenzene-2,4-anhydride, 4-(4-carboxyphenoxy)phthalic anhydride, aconitic anhydride, 1,2,3-benzenetricarboxylic anhydride, 1,2,4-naphthalene tricarboxylic anhydride, 1,2,5-naphthalene tricarboxylic anhydride, 1,2,6-naphthalene tricarboxylic anhydride, 1,2,7-naphthalene tricarboxylic anhydride, 1,2,8-naphthalene tricarboxylic anhydride, 1,3,8-naphthalene tricarboxylic anhydride, 4,5-naphthalene tricarboxylic anhydride, 1,6,7-naphthalene tricarboxylic anhydride, 2,3,5-naphthalene tricarboxylic anhydride, 2,3,6-naphthalene tricarboxylic anhydride, 3,4,4′-benzophenone tricarboxylic anhydride, 3,4,4′-biphenyl ether tricarboxylic anhydride, 3,4,4′-biphenyl tricarboxylic anhydride, 2,3,2′-biphenyl tricarboxylic anhydride, 3,4,4′-biphenyl methanetricarboxylic anhydride, 3,4,4′-biphenyl sulfone tricarboxylic anhydride, or a combination of the compounds. The tricarboxylic anhydride compound (a-2) can be used alone or in multiple combinations.

The tricarboxylic anhydride compound (a-2) preferably includes a cyclic tricarboxylic anhydride compound, wherein the tricarboxylic anhydride compound includes an alicyclic tricarboxylic anhydride compound such as 1,2,3-tricarboxycyclopropane-1,2-anhydride, 1,2,3-tricarboxycyclobutane-1,2-anhydride, 1,2,4-tricarboxycyclohexane-1,2-anhydride, or norbornane tricarboxylic anhydride; an aromatic tricarboxylic anhydride compound such as trimellitic anhydride, 1,2,3-tricarboxybenzene-1,2-anhydride, 1,2,5-naphthalene tricarboxylic anhydride, 1,4,5-naphthalene tricarboxylic anhydride, 2,3,5-naphthalene tricarboxylic anhydride, 2,3,6-naphthalene tricarboxylic anhydride, 4-(4-carboxyphenoxy)phthalic anhydride, 3,4,4′-benzophenone tricarboxylic anhydride, or 3,4,4′-biphenyl ether tricarboxylic anhydride; or a combination of the compounds. When the tricarboxylic anhydride compound (a-2) includes a cyclic tricarboxylic anhydride compound, ultraviolet reliability of the liquid crystal alignment film formed by the liquid crystal alignment agent can further be increased.

Based on a total number of moles of 100 moles of the carboxylic anhydride component (a), the usage amount of the tricarboxylic anhydride compound (a-2) can be 1 mole to 50 moles, preferably 3 moles to 45 moles, and more preferably 5 moles to 40 moles. When the tricarboxylic anhydride compound (a-2) is not used in the liquid crystal alignment agent, the ultraviolet reliability of the obtained liquid crystal alignment film is poor.

### Diamine Component (b)

The diamine component (b) includes a diamine compound (b-1) represented by formula (I).

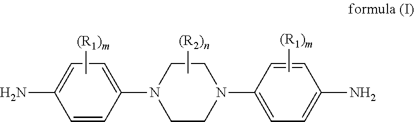

In formula (I), R₁ each independently represents a hydrogen atom, a C₁ to C₁₀ alkyl group, a C₁ to C₁₀ alkoxy group, an acetamido group, a fluorine atom, a chlorine atom, or a bromine atom; R₂ each independently represents a C₁ to C₃ alkyl group; m each independently represents an integer of 0 to 3; and n represents an integer of 0 to 4.

In formula (I), R₁ preferably each independently represents a hydrogen atom, a C₁ to C₁₀ alkyl group, a C₁ to C₁₀ alkoxy group, or an acetamido group. When R₁ each independently represents a hydrogen atom, a C₁ to C₁₀ alkyl group, a C₁ to C₁₀ alkoxy group, or an acetamido group, ultraviolet reliability of the liquid crystal alignment film formed by the liquid crystal alignment agent can further be improved.

Specific examples of the compound represented by formula (I) include, but are not limited to, at least one of the diamine compounds represented by formula (I-1) to formula (I-28).

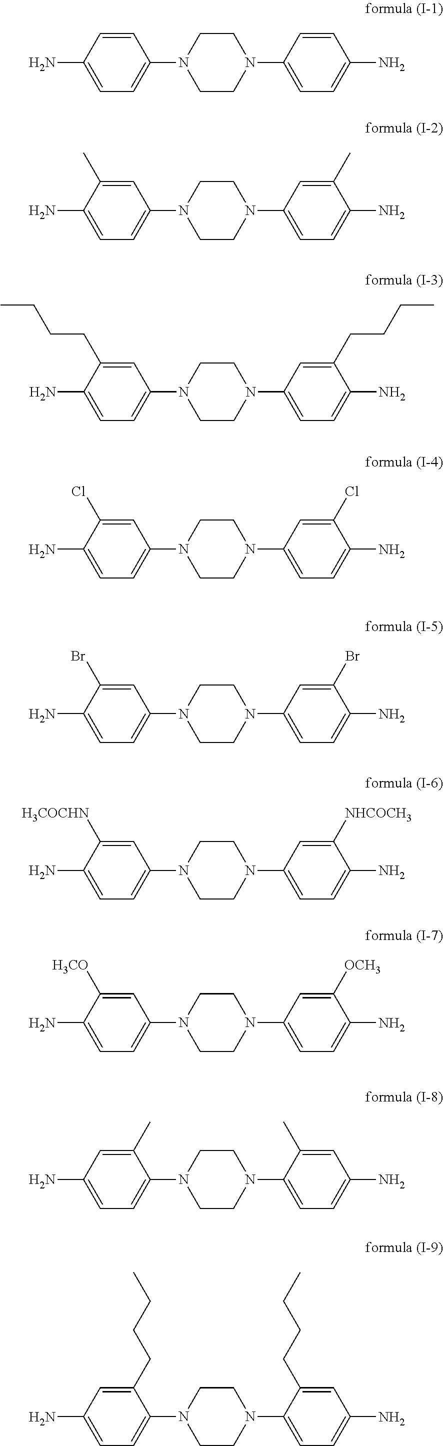

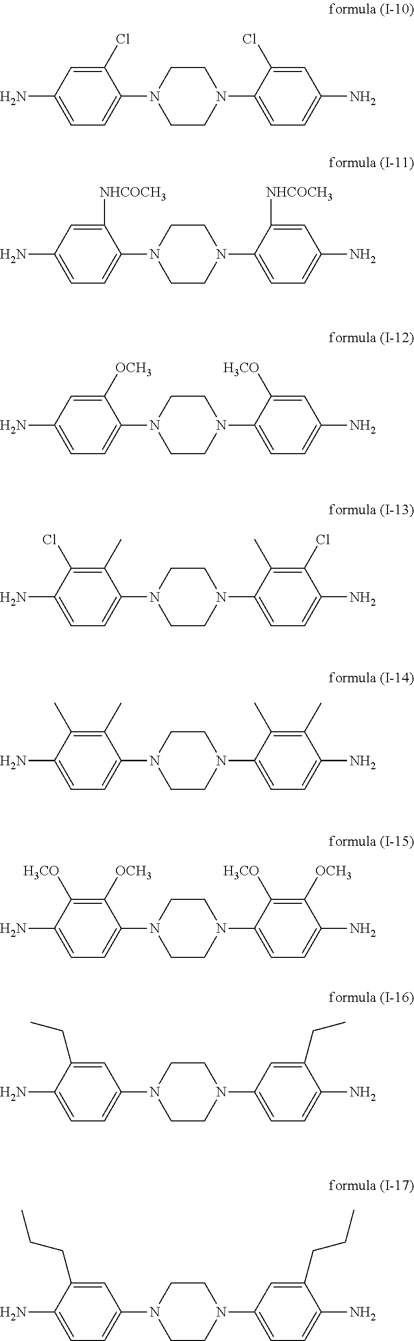

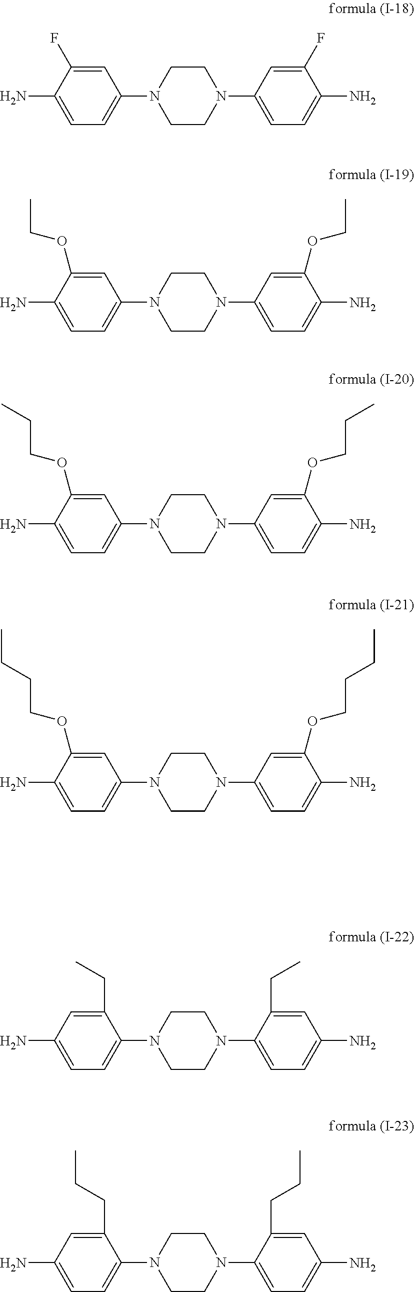 [SMILES: Nc1ccc(N2CCN(c3ccc(N)c(F)c3)CC2)cc1F ; CCOc1cc(N2CCN(c3ccc(N)c(OCC)c3)CC2)ccc1N ; CCCOc1cc(N2CCN(c3ccc(N)c(OCCC)c3)CC2)ccc1N ; CCCCOc1cc(N2CCN(c3ccc(N)c(OCCCC)c3)CC2)ccc1N ; CCc1cc(N)ccc1N1CCN(c2ccc(N)cc2CC)CC1 ; CCCc1cc(N)ccc1N1CCN(c2ccc(N)cc2CCC)CC1]

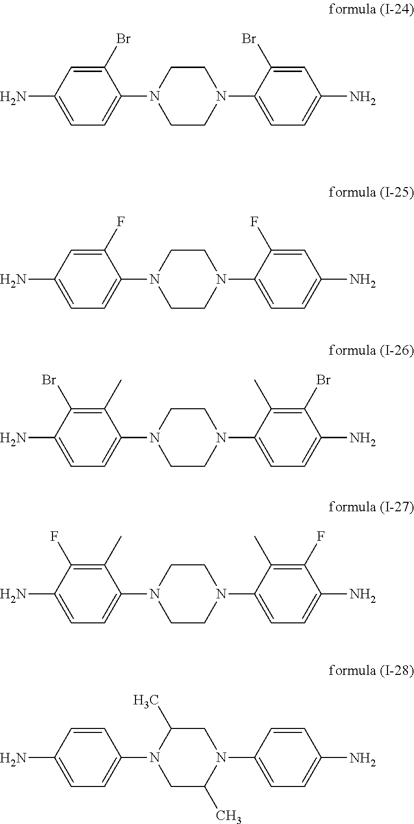 [SMILES: Nc1ccc(N2CCN(c3ccc(N)cc3Br)CC2)c(Br)c1 ; Nc1ccc(N2CCN(c3ccc(N)cc3F)CC2)c(F)c1 ; Cc1c(N2CCN(c3ccc(N)c(Br)c3C)CC2)ccc(N)c1Br ; Cc1c(N2CCN(c3ccc(N)c(F)c3C)CC2)ccc(N)c1F ; CC1CN(c2ccc(N)cc2)C(C)CN1c1ccc(N)cc1]

The diamine compound (b-1) can be used alone or in multiple combinations.

Based on a total number of moles of 100 moles of the diamine component (b), the usage amount of the diamine compound (b-1) can be 1 mole to 80 moles, preferably 10 moles to 70 moles, and more preferably 20 moles to 60 moles. When the diamine compound (b-1) is not used in the liquid crystal alignment agent, the issue of excessive ion density of the obtained liquid crystal display element formed by the liquid crystal alignment agent occurs.

The molar ratio (a-2)/(b-1) of the tricarboxylic anhydride compound (a-2) and the diamine compound (b-1) can be 0.1 to 5, preferably 0.3 to 4, and more preferably 0.5 to 3. When the molar ratio is in the above ranges, ultraviolet reliability of the liquid crystal alignment film formed by the liquid crystal alignment agent can further be increased.

Other Diamine Compounds (b-2)

In addition to the diamine compound (b-1), without affecting the efficacy, the diamine component (b) of the invention can also optionally be used with other diamine compounds (b-2). Specific examples of the other diamine compounds (b-2) include, but are not limited to, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy) ethane, 4,4′-diaminodicyclohexylmethane, 4,4′-diamino-3,3′-dimethyldicyclohexylamine, 1,3-diaminocyclohexane, 1,4-diaminocyclohexane, isophorone diamine, tetrahydrodicyclopentadiene diamine, tricyclo(6.2.1.0^{2,7})-undecylenedimethyldiamine, 4,4′-methylenebis(cyclohexylamine), 4,4′-diaminodiphenylmethane, 4,4′-diaminodiphenyl ethane, 4,4′-diaminodiphenylsulfone, 4,4′-diaminobenzanilide, 4,4′-diaminodiphenyl ether, 3,4′-diaminodiphenyl ether, 1,5-diaminonaphthalene, 5-amino-1-(4′-aminophenyl)-1,3,3-trimethyl indane, 6-amino-1-(4′-aminophenyl)-1,3,3-trimethyl indane, hexahydro-4,7-methanoindanylenedimethylenediamine, 3,3′-diamino benzophenone, 3,4′-diamino benzophenone, 4,4′-diamino benzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoro-propane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenylene isopropylidene)bisaniline, 4,4′-(m-phenylene isopropylidene)bisaniline, 2,2′-bis[4-(4-amino-2-trifluoromethylphenoxy)phenyl]hexafluoropropane, 4,4′-bis[(4-amino-2-trifluoromethyl)phenoxy]-octafluorobiphenyl, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, at least one of the diamine compounds represented by formula (II-1) to formula (II-30), or a combination of the compounds.

The diamine compounds represented by formula (II-1) to formula (II-30) are as shown below.

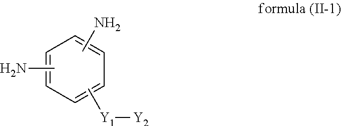

In formula (II-1), Y₁ represents

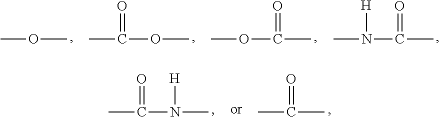

Y² represents a steroid-containing group, a trifluoromethyl group, a fluorine group, a C₂ to C₃₀ alkyl group, or a monovalent group of a cyclic structure containing a nitrogen atom derived from, for instance, pyridine, pyrimidine, triazine, piperidine, or piperazine.

Specific examples of the compound represented by formula (II-1) include, but are not limited to, 2,4-diaminophenyl ethyl formate, 3,5-diaminophenyl ethyl formate, 2,4-diaminophenyl propyl formate, 3,5-diaminophenyl propyl formate, 1-dodecoxy-2,4-diaminobenzene, 1-hexadecoxy-2,4-diaminobenzene, 1-octadecoxy-2,4-diaminobenzene, at least one of the compounds represented by formula (II-1-1) to formula (II-1-6), or a combination of the compounds.

The compounds represented by formula (II-1-1) to formula (II-1-6) are as shown below.

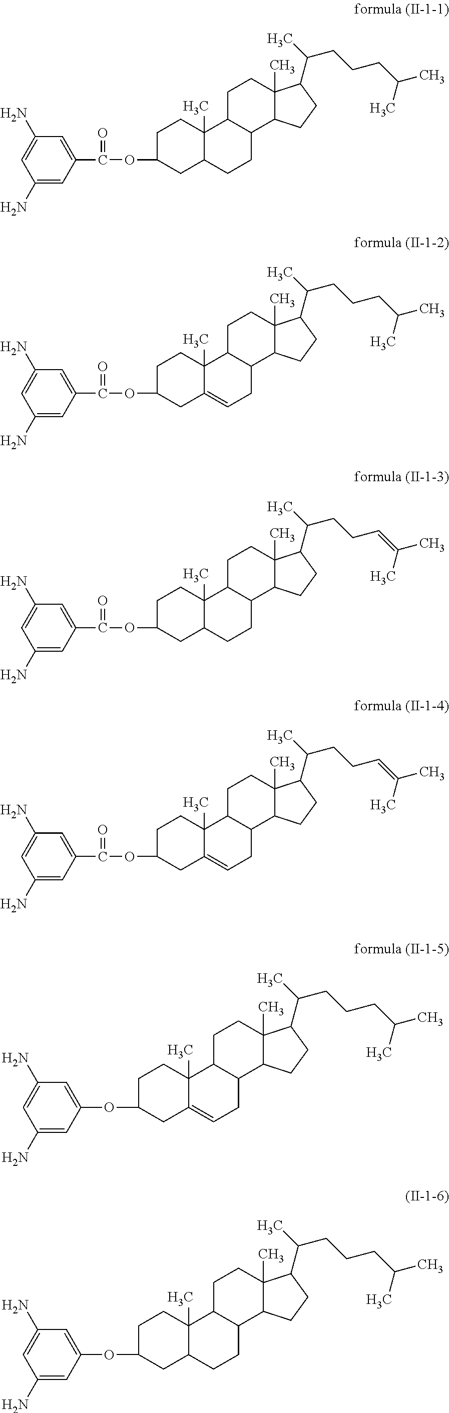

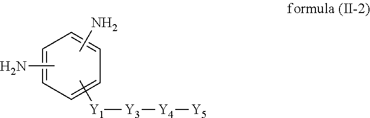

In formula (II-2), Y₁ is the same as the Y₁ in formula (II-1), Y₃ and Y₄ each independently represent a divalent aliphatic ring, a divalent aromatic ring, or a divalent heterocyclic group; Y₅ represents a C₃ to C₁₈ alkyl group, a C₃ to C₁₈ alkoxy group, a C₁ to C₅ fluoroalkyl group, a C₁ to C₅ fluoroalkyloxy group, a cyano group, or a halogen atom.

Specific examples of the compound represented by formula (II-2) include at least one of the compounds represented by formula (II-2-1) to formula (II-2-13). Specifically, the compounds represented by formula (II-2-1) to formula (II-2-13) are as follows.

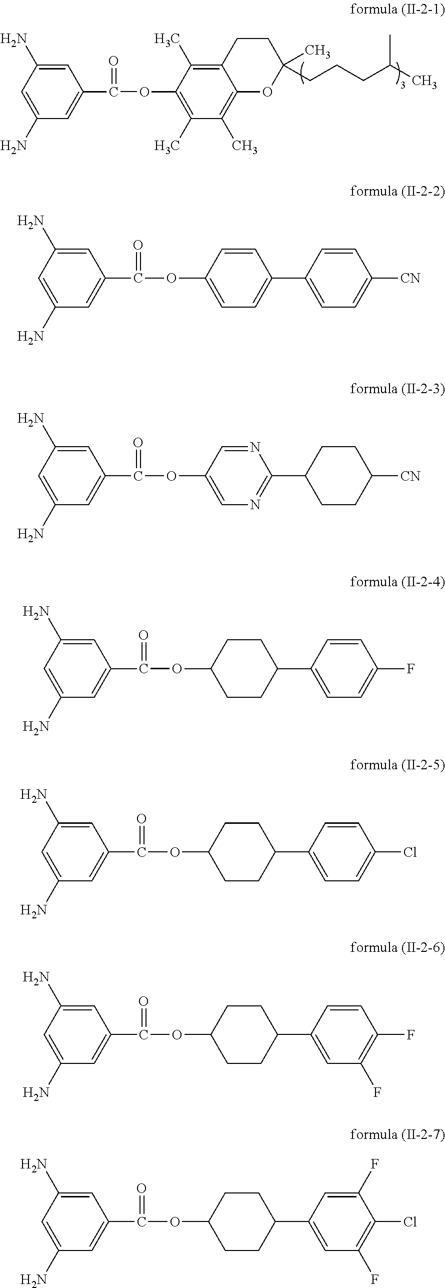

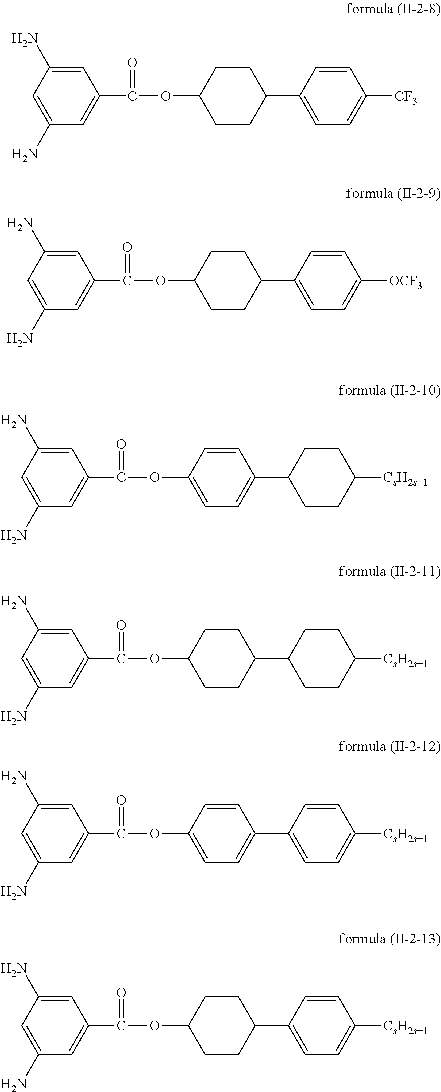

In formula (II-2-10) to formula (II-2-13), s represents an integer of 3 to 12.

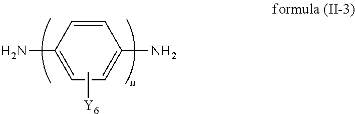

In formula (II-3), Y⁶ each independently represents a hydrogen atom, a C₁ to C₅ acyl group, a C₁ to C₅ alkyl group, a C₁ to C₅ alkoxy group, or a halogen atom, and Y₆ in each repeating unit can be the same or different; and u represents an integer of 1 to 3.

Specific examples of the compound represented by formula (II-3) include: (1) when u is 1: p-diaminobenzene, m-diaminobenzene, o-diaminobenzene, or 2,5-diaminotoluene . . . etc.; (2) when u is 2: 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diamino biphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, or 4,4′-diamino-2,2′-bis(trifluoromethyl) biphenyl . . . etc.; or (3) when u is 3: 1,4-bis(4′-aminophenyl)benzene . . . etc.

Specific examples of the compound represented by formula (II-3) preferably include p-diaminobenzene, 2,5-diaminotoluene, 4,4′-diaminobiphenyl, 3,3′-dimethoxy-4,4′-diaminobiphenyl, 1,4-bis(4′-aminophenyl)benzene, or a combination of the compounds.

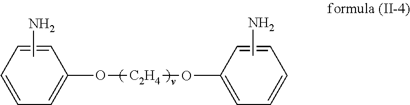

In formula (II-4), v represents an integer of 2 to 12.

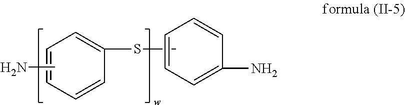

In formula (II-5), w represents an integer of 1 to 5. The compound represented by formula (II-5) is preferably 4,4′-diamino-diphenyl sulfide.

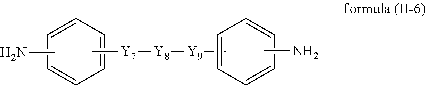

In formula (II-6), Y₇ and Y₉ each independently represent a divalent organic group, and Y₇ and Y₉ can be the same or different; Y₈ represents a divalent group of a cyclic structure containing a nitrogen atom derived from, for instance, pyridine, pyrimidine, triazine, piperidine, or piperazine.

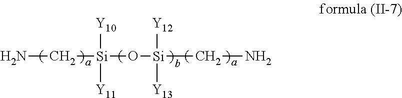

In formula (II-7), Y₁₀, Y₁₁, Y₁₂, and Y₁₃ each independently represent a C₁ to C₁₂ hydrocarbon group, and Y₁₀, Y₁₁, Y₁₂, and Y₁₃ can be the same or different; a each independently represents an integer of 1 to 3; and b represents an integer of 1 to 20.

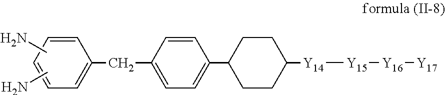

In formula (II-8), Y₁₄ represents an oxygen atom or a cyclohexylene group; Y₁₅ represents a methylene group (—CH₂); Y₁₆ represents a phenylene group or a cyclohexylene group; and Y₁₇ represents a hydrogen atom or a heptyl group.

Specific examples of the compound represented by formula (II-8) include a compound represented by formula (II-8-1), a compound represented by formula (II-8-2), or a combination of the compounds.

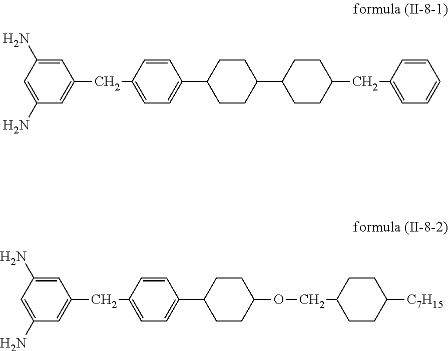

The compounds represented by formula (II-9) to formula (II-30) are as shown below.

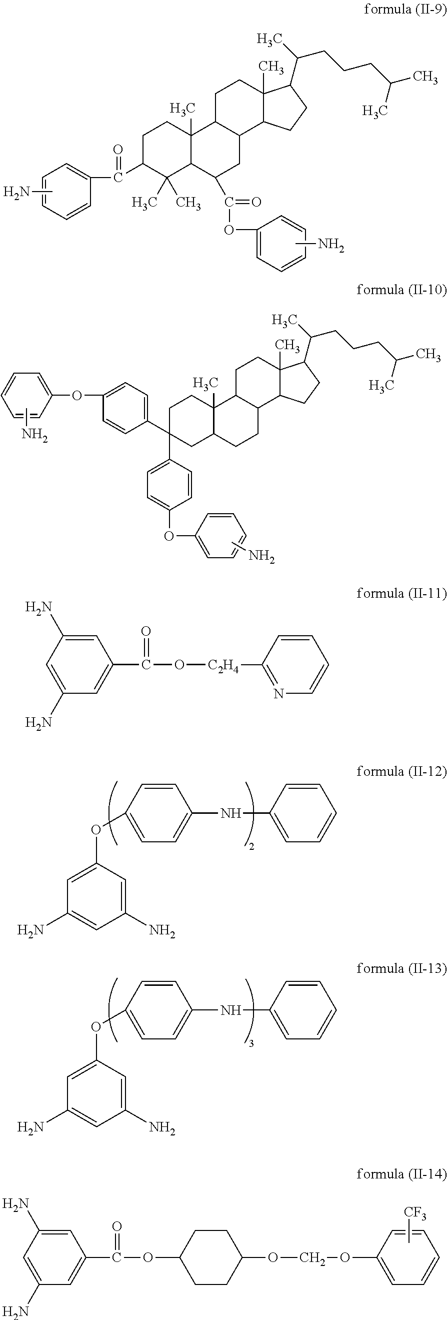

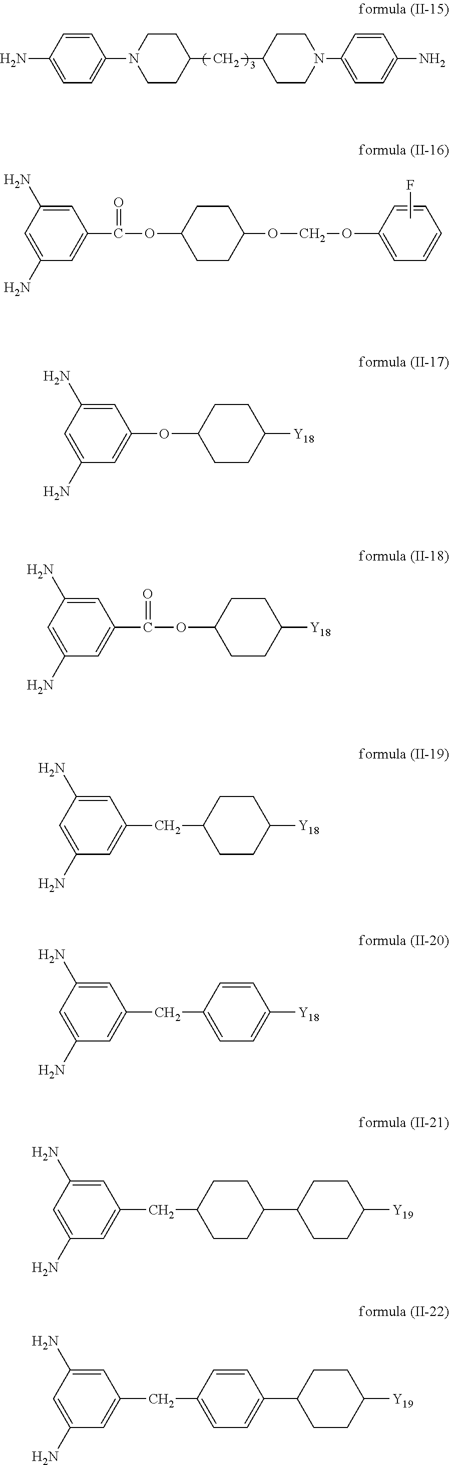

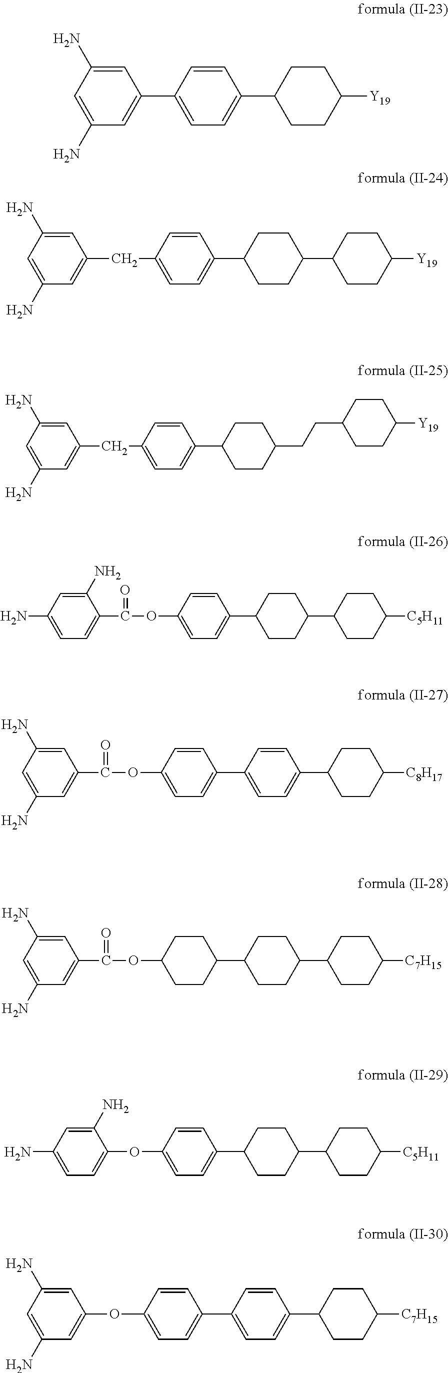

In formula (II-17) to formula (II-25), Y₁₈ preferably represents a C₁ to C₁₀ alkyl group or a C₁ to C₁₀ alkoxy group; and Y₁₉ preferably represents a hydrogen atom, a C₁ to C₁₀ alkyl group, or a C₁ to C₁₀ alkoxy group.

Specific examples of the other diamine compounds (b-2) preferably include, but are not limited to, 1,2-diaminoethane, 4,4′-diaminodicyclohexylmethane, 4,4′-diaminodiphenylmethane, 4,4′-diaminodiphenyl ether, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, 2,4-diaminophenyl ethyl formate, a compound represented by formula (II-1-1), a compound represented by formula (II-1-2), a compound represented by formula (II-1-5), a compound represented by formula (II-2-1), a compound represented by formula (II-2-11), p-diaminobenzene, m-diaminobenzene, o-diaminobenzene, a compound represented by formula (II-8-1), a compound represented by formula (II-26), a compound represented by formula (II-29), or a combination of the compounds.

The other diamine compounds (b-2) can be used alone or in multiple combinations.

Based on a total number of moles of 100 moles of the diamine component (b), the usage amount of the other diamine compounds (b-2) can be 20 moles to 99 moles, preferably 30 moles to 90 moles, and more preferably 40 moles to 80 moles.

### Method of Preparing Polymer Composition (A)

The polymer composition (A) can include polyamic acid, polyimide, a polyimide-based block copolymer, or a combination of the polymers. The preparation method of each of the various polymers above is further described below.

### Method of Preparing Polyamic Acid

The method of preparing the polyamic acid includes first dissolving a mixture in a solvent and performing a polycondensation reaction at a temperature of 0° C. to 100° C. to form a reaction solution, wherein the mixture includes the carboxylic anhydride component (a) and the diamine component (b). The order of dissolving the carboxylic anhydride component (a) and the diamine component (b) in the solvent is not particularly limited. Specifically, for instance, all of the carboxylic anhydride component (a) and the diamine component (b) can be dissolved in the solvent at the same time. Alternatively, a portion of the carboxylic anhydride component (a) and a portion of the diamine component (b) can also be dissolved in a portion of the solvent first, and then the remaining carboxylic anhydride component (a), diamine component (b), and solvent are added. In an embodiment, the method of preparing the polyamic acid includes first dissolving the tricarboxylic anhydride compound (a-2) and the diamine compound (b-1) in a portion of the solvent, and then adding the tetracarboxylic dianhydride compound (a-1), the other diamine compounds (b-2), and the solvent.

After the reaction solution was reacted for 1 hour to 24 hours, distillation under reduced pressure was performed on the reaction solution with an evaporator, thereby obtaining the polyamic acid. Alternatively, the reaction solution is poured into a large amount of a poor solvent to obtain a precipitate. Then, the precipitate is dried with a method of drying under reduced pressure to obtain the polyamic acid.

In the mixture, based on a total usage amount of 100 moles of the diamine component (b), the usage amount of the carboxylic anhydride component (a) is preferably 20 moles to 200 moles, more preferably 30 moles to 120 moles.

The solvent used in the polycondensation reaction can be the same or different as the solvent in the liquid crystal alignment agent below, and the solvent used in the polycondensation reaction is not particularly limited, provided the solvent can dissolve the reactants and the products. The solvent preferably includes, but is not limited to (1) an aprotic polar solvent such as N-methyl-2-pyrrolidinone (NMP), N,N-dimethyl acetamide, N,N-dimethyl formamide, dimethyl sulfoxide, γ-butyrolactone, tetramethylurea, or hexamethylphosphor amide; or (2) a phenolic solvent such as m-cresol, xylenol, phenol, or halogenated phenol. Based on a total usage amount of 100 parts by weight of the mixture, the usage amount of the solvent used in the polycondensation reaction is preferably 200 parts by weight to 2000 parts by weight, more preferably 300 parts by weight to 1800 parts by weight.

It should be mentioned that, in the polycondensation reaction, the solvent can be used with a suitable amount of a poor solvent, wherein the poor solvent does not cause precipitation of the polyamic acid. The poor solvent can be used alone or in multiple combinations, and includes, but is not limited to (1) an alcohol such as methanol, ethanol, isopropanol, cyclohexanol, ethylene glycol, propylene glycol, 1,4-butanediol, or triglycol; (2) a ketone such as acetone, methyl ethyl ketone, methyl isobutyl ketone, or cyclohexanone; (3) an ester such as methyl acetate, ethyl acetate, butyl acetate, diethyl oxalate, diethyl malonate, or ethylene glycol monoethyl ether acetate; (4) an ether such as diethyl ether, ethylene glycol monomethyl ether, ethylene glycol monoethyl ether, ethylene glycol n-propyl ether, ethylene glycol isopropyl ether, ethylene glycol n-butyl ether, ethylene glycol dimethyl ether, or diethylene glycol dimethyl ether; (5) a halogenated hydrocarbon such as dichloromethane, 1,2-dichloroethane, 1,4-dichlorobutane, trichloroethane, chlorobenzene, or o-dichlorobenzene; or (6) a hydrocarbon such as tetrahydrofuran, hexane, heptane, octane, benzene, toluene, or xylene, or any combination of the solvents. Based on a usage amount of 100 parts by weight of the diamine component (b), the usage amount of the poor solvent is preferably 0 parts by weight to 60 parts by weight, more preferably 0 parts by weight to 50 parts by weight.

### Method of Preparing Polyimide

The method of preparing the polyimide includes heating the polyamic acid obtained by the above method of preparing polyamic acid under the existence of a dehydrating agent and a catalyst. During the heating process, the amic acid functional group in the polyamic acid can be converted into an imide functional group through a cyclodehydration reaction (i.e., imidization).

The solvent used in the cyclodehydration reaction can be the same as the solvent (B) in the liquid crystal alignment agent and is therefore not repeated herein. Based on a usage amount of 100 parts by weight of the polyamic acid, the usage amount of the solvent used in the cyclodehydration reaction is preferably 200 parts by weight to 2000 parts by weight, more preferably 300 parts by weight to 1800 parts by weight.

To obtain a preferable degree of imidization of the polyamic acid, the operating temperature of the cyclodehydration reaction is preferably 40° C. to 200° C., more preferably 40° C. to 150° C. If the operating temperature of the cyclodehydration reaction is less than 40° C., then the imidization reaction is incomplete, and the degree of imidization of the polyamic acid is thereby reduced. However, if the operating temperature of the cyclodehydration reaction is higher than 200° C., then the weight-average molecular weight of the obtained polyimide is lower.

The dehydrating agent used in the cyclodehydration reaction can be selected from an anhydride compound, and specific examples thereof include, for instance, acetic anhydride, propionic anhydride, or trifluoroacetic anhydride. Based on 1 mole of the polyamic acid, the usage amount of the dehydrating agent is 0.01 moles to 20 moles. The catalyst used in the cyclodehydration reaction can be selected from (1) a pyridine compound such as pyridine, trimethyl pyridine, or dimethyl pyridine; or (2) a tertiary amine compound such as triethylamine. Based on a usage amount of 1 mole of the dehydrating agent, the usage amount of the catalyst can be 0.5 moles to 10 moles.

### Method of Preparing Polyimide-Based Block Copolymer

The polyimide-based block copolymer is selected from a polyamic acid block copolymer, a polyimide block copolymer, a polyamic acid-polyimide block copolymer, or any combination of the polymers.

The method of preparing the polyimide-based block copolymer preferably includes first dissolving a starting material in a solvent and then performing a polycondensation reaction, wherein the starting material includes at least one type of polyamic acid and/or at least one type of polyimide, and can further include a carboxylic anhydride component and a diamine component.

The carboxylic anhydride component and the diamine component in the starting material can be the same as the carboxylic anhydride component (a) and the diamine component (b) used in the method of preparing the polyamic acid polymer. Moreover, the solvent used in the polycondensation reaction can be the same as the solvent in the liquid crystal alignment agent below and is not repeated herein.

Based on a usage amount of 100 parts by weight of the starting material, the usage amount of the solvent used in the polycondensation reaction is preferably 200 parts by weight to 2000 parts by weight, more preferably 300 parts by weight to 1800 parts by weight. The operating temperature of the polycondensation reaction is preferably 0° C. to 200° C., more preferably 0° C. to 100° C.

The starting material preferably includes, but is not limited to (1) two polyamic acids for which the terminal groups are different and the structures are different; (2) two polyimides for which the terminal groups are different and the structures are different; (3) a polyamic acid and a polyimide for which the terminal groups are different and the structures are different; (4) a polyamic acid, a carboxylic anhydride component, and a diamine component, wherein the structure of at least one of the carboxylic anhydride component and the diamine component is different from the structures of the carboxylic anhydride component and the diamine component used to form the polyamic acid; (5) a polyimide, a carboxylic anhydride component, and a diamine component, wherein the structure of at least one of the carboxylic anhydride component and the diamine component is different from the structures of the carboxylic anhydride component and the diamine component used to form the polyimide; (6) a polyamic acid, a polyimide, a carboxylic anhydride component, and a diamine component, wherein the structure of at least one of the carboxylic anhydride component and the diamine component is different from the structures of the carboxylic anhydride component and the diamine component used to the polyamic acid or the polyimide; (7) two polyamic acids having different structures, a carboxylic anhydride component, and a diamine component; (8) two polyimides having different structures, a carboxylic anhydride component, and a diamine component; (9) two polyamic acids having anhydride groups as terminal groups and having different structures, and a diamine component; (10) two polyamic acids having amine groups as terminal groups and having different structures, and a carboxylic anhydride component; (11) two polyimides having anhydride groups as terminal groups and having different structures, and a diamine component; or (12) two polyimides having amine groups as terminal groups and having different structures, and a carboxylic anhydride component.

Without affecting the efficacy of the invention, the polyamic acid, the polyimide, and the polyimide-based block copolymer are preferably terminal-modified polymers in which molecular weight regulation is first performed. By using the terminal-modified polymers, the coating performance of the liquid crystal alignment agent can be improved. The method of preparing the terminal-modified polymers can include adding a monofunctional compound at the same time a polycondensation reaction is performed on the polyamic acid.

Specific examples of the monofunctional compound include, but are not limited to, (1) a monoanhydride such as maleic anhydride, phthalic anhydride, itaconic anhydride, n-decyl succinic anhydride, n-dodecyl succinic anhydride, n-tetradecyl succinic anhydride, or n-hexadecyl succinic anhydride; (2) a monoamine compound such as aniline, cyclohexylamine, n-butylamine, n-amylamine, n-hexylamine, n-heptylamine, n-octylamine, n-nonylamine, n-decylamine, n-undecylamine, n-do decyl amine, n-tridecylamine, n-tetradecylamine, n-pentadecylamine, n-hexadecylamine, n-heptadecylamine, n-octadecylamine, or n-eicosylamine; or (3) a monoisocyanate compound such as phenyl isocyanate or naphthyl isocyanate.

### Solvent (B)

Specific examples of the solvent (B) include, but are not limited to, for instance, N-methyl-2-pyrrolidone (NMP), γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol monoethyl ether, ethylene glycol n-propyl ether, ethylene glycol isopropyl ether, ethylene glycol n-butyl ether, ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, N,N-dimethyl formamide, or N,N-dimethyl acetamide. The solvent (B) can be used alone or in multiple combinations.

Based on a usage amount of 100 parts by weight of the polymer composition (A), the usage amount of the solvent (B) is 500 parts by weight to 3000 parts by weight, preferably 800 parts by weight to 2500 parts by weight, and more preferably 1000 parts by weight to 2000 parts by weight. When the usage amount of the solvent (B) in the liquid crystal alignment agent is within the above ranges, the printability of the liquid crystal alignment agent can further be improved.

### Compound (C) Having at Least Two Epoxy Groups

The liquid crystal alignment agent of the invention can optionally include a compound (C) having at least two epoxy groups.

The compound (C) having at least two epoxy groups includes, but is not limited to, ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerol diglycidyl ether, 2,2-dibromo-neopentyl glycol diglycidyl ether, 1,3,5,6-tetraglycidyl-2,4-hexanediol, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, N,N-glycidyl-p-glycidyloxy aniline, 3-(N-allyl-N-glycidyl)aminopropyltrimethoxysilane, 3-(N,N-diglycidyl)aminopropyltrimethoxysilane, or a combination of the compounds.

The compound (C) having at least two epoxy groups can be used alone or in multiple combinations.

Based on a usage amount of 100 parts by weight of the polymer composition (A), the usage amount of the compound (C) having at least two epoxy groups can be 0 parts by weight to 40 parts by weight, preferably 0.1 parts by weight to 30 parts by weight. When the compound (C) having at least two epoxy groups is used in the liquid crystal alignment agent, ion density of the obtained liquid crystal display element formed by the liquid crystal alignment agent can further be reduced.

### Additive (D)

Without affecting the efficacy of the invention, an additive (D) can also optionally be added to the liquid crystal alignment agent, wherein the additive (D) can be a silane compound having a functional group.

Specific examples of the silane compound having a functional group include, but are not limited to, 3-aminopropyltrimethoxysilane, 3-aminopropyltriethoxysilane, 2-amino propyltrimethoxysilane, 2-aminopropyltriethoxysilane, N-(2-aminoethyl)-3-aminopropyl trimethoxysilane, N-(2-aminoethyl)-3-aminopropyldimethoxysilane, 3-ureidopropyl trimethoxysilane, 3-ureidopropyltriethoxysilane, N-ethoxycarbonyl-3-aminopropyl trimethoxysilane, N-ethoxycarbonyl-3-aminopropyltriethoxysilane, N-triethoxysilylpropyl triethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, N-bis(oxyethylene)-3-aminopropyltriethoxysilane, or a combination of the compounds. The additive (D) can be used alone or in multiple combinations.

Based on a total usage amount of 100 parts by weight of the polymer composition (A), the usage amount of the additive (D) is preferably 0.5 parts by weight to 50 parts by weight, more preferably 1 part by weight to 45 parts by weight.

### <Preparation Method of Liquid Crystal Alignment Agent>

The preparation method of the liquid crystal alignment agent is not particularly limited, and a general mixing method can be used for the preparation. For instance, the polymer composition (A) is first added to the solvent (B) at a temperature of 0° C. to 200° C., and the compound (C) having at least two epoxy groups, the additive (D), or a combination of the two is optionally added. Next, the mixture is continuously stirred by using a stirring apparatus until the mixture is dissolved. Moreover, the polymer composition (A) is preferably added to the solvent (B) at a temperature of 20° C. to 60° C.

### <Preparation Method of Liquid Crystal Alignment Film>

The liquid crystal alignment film of the invention can be formed by the above liquid crystal alignment agent.

Specifically, the preparation method of the liquid crystal alignment film can include, for instance: coating the liquid crystal alignment agent on the surface of a substrate with a method such as a roll coating method, a spin coating method, a printing method, or an ink jet method to form a pre-coat layer. Then, a pre-bake treatment, a post-bake treatment, and an alignment treatment are performed on the pre-coat layer to obtain a substrate on which a liquid crystal alignment film is formed.

The purpose of the pre-bake treatment is to volatilize the organic solvent in the pre-coat layer. The operating temperature of the pre-bake treatment is preferably 30° C. to 120° C., more preferably 40° C. to 110° C., and even more preferably 50° C. to 100° C.

The alignment treatment is not particularly limited, and can include wrapping a cloth made from a fiber such as nylon, rayon, or cotton on a roller and performing alignment by rubbing in a certain direction.

The purpose of the post-bake treatment is to further perform a cyclodehydration (imidization) reaction on the polymer in the pre-coat layer. The operating temperature of the post-bake treatment is preferably 150° C. to 300° C., more preferably 180° C. to 280° C., and even more preferably 200° C. to 250° C.

### <Liquid Crystal Display Element and Preparation Method Thereof>

The liquid crystal display element of the invention includes the liquid crystal alignment film formed by the liquid crystal alignment agent of the invention. The liquid crystal display element of the invention can be made according to the following method.

Two substrates on which a liquid crystal alignment film is formed are prepared, and a liquid crystal is disposed between the two substrates to make a liquid crystal cell. To make the liquid crystal cell, the following two methods can be provided.

The first method includes first disposing the two substrates opposite to each other with a gap (cell gap) in between such that each liquid crystal alignment film is opposite to one another. Then, the peripherals of the two substrates are laminated together with a sealant. Next, liquid crystal is injected into the cell gap divided by the substrate surfaces and the sealant, and then the injection hole is sealed to obtain the liquid crystal cell.

The second method is called ODF (one drop fill, instillation). First, an ultraviolet curable sealing material for instance is coated on a predetermined portion on one of the two substrates forming the liquid crystal alignment films. Then, liquid crystal is dropped onto the liquid crystal alignment film, and then the other substrate is laminated such that the liquid crystal alignment films are opposite to each other. Next, ultraviolet is irradiated on the entire substrate surface such that the sealant is cured. The liquid crystal cell can thus be made.

When any one of the above methods is used, preferably, after the liquid crystal cell is next heated to the temperature at which the liquid crystal used is in an isotropic phase, the liquid crystal cell is slowly cooled to room temperature to remove the flow alignment when the liquid crystal is filled.

Next, by bonding a polarizer on the outer surface of the liquid crystal cell, the IPS-type liquid crystal display element of the invention can be obtained.

Specific examples of the sealant include, for instance, an epoxy resin used as a curing agent and an alumina ball used as a spacer.

The polarizer used on the outside of the liquid crystal cell can include, for instance, a polarizer formed by a polarizing film known as “H film” obtained when iodine is absorbed at the same time that polyvinyl alcohol is stretch aligned by clamping with a cellulose acetate protective film, or a polarizer formed by the “H film” itself.

The liquid crystal display element of the invention thus made has excellent display performance, and even after prolonged use, the display performance is not worsened.

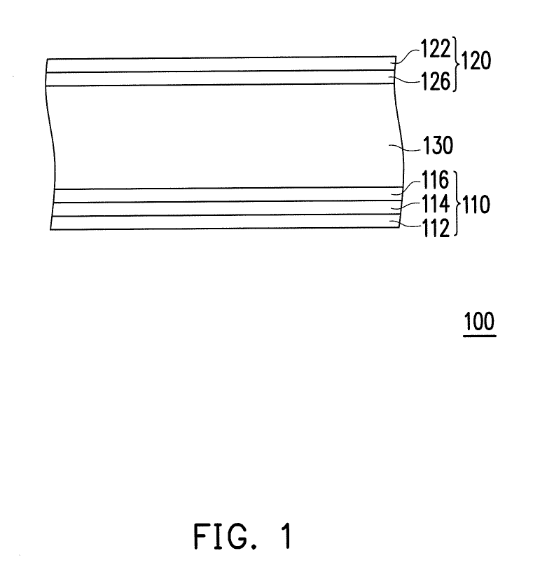

FIG. 1 is a side view of a liquid crystal display element according to an embodiment of the invention. A liquid crystal display element 100 includes a first unit 110, a second unit 120, and a liquid crystal unit 130, wherein the second unit 120 and the first unit 110 are separately disposed and the liquid crystal unit 130 is disposed between the first unit 110 and the second unit 120.

The first unit 110 includes a first substrate 112, an electrode 114, and a first liquid crystal alignment film 116, wherein the electrode 114 is located between the first substrate 112 and the first liquid crystal alignment film 116, and the first liquid crystal alignment film 116 is located on one side of the liquid crystal unit 130.

The second unit 120 includes a second substrate 122 and a second liquid crystal alignment film 126, wherein the second liquid crystal alignment film 126 is located on another side of the liquid crystal unit 130. In other words, the liquid crystal unit 130 is located between the first liquid crystal alignment film 116 and the second liquid crystal alignment film 126.

The first substrate 112 and the second substrate 122 are selected from, for instance, a transparent material, wherein the transparent material includes, but is not limited to, for instance, alkali-free glass, soda-lime glass, hard glass (Pyrex glass), quartz glass, polyethylene terephthalate, polybutylene terephthalate, polyethersulfone, or polycarbonate. The material of the electrode 114 is selected from a transparent electrode such as tin oxide (SnO₂) or indium oxide-tin oxide (In₂O₃—SnO₂), or a metal electrode such as chromium.

The first liquid crystal alignment film 116 and the second liquid crystal alignment film 126 are respectively the liquid crystal alignment films above, and the function thereof is to make the liquid crystal unit 130 form a pretilt angle. Moreover, the electrode 114 contains a pixel electrode and a common electrode, and when a voltage is applied to the electrode 114, the electrode 114 can generate a parallel electric field. Here, the parallel electric field can drive the liquid crystal unit 130, thereby causing change to the arrangement of the liquid crystal molecules in the liquid crystal unit 130. The liquid crystal used in the liquid crystal unit 130 can be used alone or as a mixture, and the liquid crystal includes, but is not limited to, for instance, a diaminobenzene-based liquid crystal, a pyridazine-based liquid crystal, a Schiff base-based liquid crystal, an azoxy-based liquid crystal, a biphenyl-based liquid crystal, a phenylcyclohexane-based liquid crystal, an ester-based liquid crystal, a terphenyl-based liquid crystal, a biphenylcyclohexane-based liquid crystal, a pyrimidine-based liquid crystal, a dioxane-based liquid crystal, a bicyclooctane-based liquid crystal, or a cubane-based liquid crystal. Moreover, a cholesterol-type liquid crystal such as cholesteryl chloride, cholesteryl nonanoate, or cholesteryl carbonate, a chiral agent such as C-15 or CB-15 (made by Merck & Co.), or a ferroelectric-based liquid crystal such as p-decyloxybenzylidene-p-amino-2-methylbutyl cinnamate can further be added as needed.

The liquid crystal display element fabricated by the liquid crystal alignment agent of the invention can be various liquid crystal display elements such as a twisted nematic (TN)-type, a super twisted nematic (STN)-type, a thin film transistor (TFT)-type, a vertical alignment (VA)-type, an IPS-type, or an optically compensated bend (OCB)-type liquid crystal display element. Moreover, based on the selected liquid crystal, the liquid crystal can also be used in different liquid crystal display elements such as a ferroelectric liquid crystal display element or an anti-ferroelectric liquid crystal display element. Among the above liquid crystal display elements, an IPS-type liquid crystal display element is preferred. In the embodiments below, the liquid crystal alignment agent is only applied in an IPS-type liquid crystal display element for illustration. However, the invention is not limited thereto.

### Synthesis Examples and Comparative Synthesis Examples of Polymer Composition (A)

Synthesis example A-1-1 to synthesis example A-1-12, synthesis example A-2-1 to synthesis example A-2-2, and comparative synthesis example A-3-1 to comparative synthesis example A-3-5 of the polymer composition (A) are described below:

### Synthesis Example A-1-1

A nitrogen inlet, a stirrer, a condenser, and a thermometer were provided in a 500 ml four-necked flask, and then nitrogen gas was introduced. Then, in a four-necked flask, 8.43 g (0.025 moles) of the diamine compound represented by formula (I-4) (b-1-1 hereinafter), 0.38 g (0.002 moles) of trimellitic anhydride (a-2-1 hereinafter), and 80 g of N-methyl-2-pyrrolidone (NMP hereinafter) were added. Next, the mixture was stirred at room temperature until the mixture was dissolved, and then 2.7 g (0.025 moles) of p-diaminobenzene (b-2-1 hereinafter), 8.82 g (0.045 moles) of 1,2,3,4-cyclobutane tetracarboxylic dianhydride (a-1-1 hereinafter), 0.9 g (0.003 moles) of 3,4-dicarboxy-1,2,3,4-tetrahydronaphthalene-1-succinic anhydride (a-1-2 hereinafter), and 20 g of NMP were added. Then, the mixture was reacted at room temperature for 2 hours. After the reaction was complete, the reaction solution was poured into 1500 ml of water to precipitate a polymer. Then, the obtained polymer was filtered and was repeatedly washed with methanol and filtered three times. The polymer was then placed in a vacuum oven and dried at a temperature of 60° C., thereby obtaining a polymer composition (A-1-1).

### Synthesis Examples A-1-2 to A-1-12

Polymer compositions (A-1-2) to (A-1-12) of synthesis examples A-1-2 to A-1-12 were respectively prepared with the same steps as synthesis example A-1-1, and the difference thereof is: the type and the usage amount of the raw materials were changed (as shown in Table 1).

The compounds corresponding to the labels in Table 1 and Table 2 are as shown below.

### ABBREVIATION COMPONENT

a-1-1 1,2,3,4-cyclobutane tetracarboxylic dianhydride
a-1-2 3,4-dicarboxy-1,2,3,4-tetrahydronaphthalene-1-succinic dianhydride
a-1-3 pyromellitic dianhydride
a-2-1 1,2,4-butanetricarboxylic-1,2-anhydride
a-2-2 3-carboxymethyl glutaric anhydride
a-2-3 trimellitic anhydride
a-2-4 1,2,5-naphthalene tricarboxylic anhydride
a-2-5 norbornane tricarboxylic anhydride
a-2-6 1,2,4-tricarboxycyclohexane-1,2-anhydride
b-1-1 compound represented by formula (I-4)
b-1-2 compound represented by formula (I-18)
b-1-3 compound represented by formula (I-5)
b-1-4 compound represented by formula (I-1)
b-1-5 compound represented by formula (I-14)
b-1-6 compound represented by formula (I-12)
b-1-7 compound represented by formula (I-6)
b-2-1 p-diaminobezene
b-2-2 4,4′-diaminodiphenylmethane
b-2-3 4,4′-diaminodiphenyl ether
b-2-4 1-octadecoxy-2,4-diaminobenzene

### Synthesis Example A-2-1

A nitrogen inlet, a stirrer, a condenser, and a thermometer were provided in a 500 ml four-necked flask, and then nitrogen gas was introduced. Then, in a four-necked flask, 8.43 g (0.025 moles) of the diamine compound (b-1-1) represented by formula (I-4), 0.38 g (0.002 moles) of trimellitic anhydride (a-2-1), and 80 g of N-methyl-2-pyrrolidone (NMP) were added. Next, the mixture was stirred at room temperature until the mixture was dissolved, and then 2.7 g (0.025 moles) of p-diaminobezene (b-2-1), 8.82 g (0.045 moles) of 1,2,3,4-cyclobutane tetracarboxylic dianhydride (a-1-1), 0.9 g (0.003 moles) of 3,4-dicarboxy-1,2,3,4-tetrahydronaphthalene-1-succinic anhydride (a-1-2), and 20 g of NMP were added. After the mixture was reacted at room temperature for 6 hours, 97 g of NMP, 2.55 g of acetic anhydride, and 19.75 g of pyridine were added. Then, the temperature was raised to 60° C., and the mixture was continuously stirred for 2 hours to perform an imidization reaction. After the reaction was complete, the reaction solution was poured into 1500 ml of water to precipitate a polymer. Then, the obtained polymer was filtered and was repeatedly washed with methanol and filtered three times. The polymer was then placed in a vacuum oven and dried at a temperature of 60° C., thereby obtaining a polymer composition (A-2-1).

### Synthesis Example A-2-2

Polymer composition (A-2-2) of synthesis example A-2-2 was prepared with the same steps as synthesis example A-2-1, and the difference thereof is: the type and the usage amount of the raw materials were changed (as shown in Table 1).

TABLE 1

| | | | Synthesis example | | | | | | | |
|---|---|---|---|---|---|---|---|---|---|---|
| Component (unit: mole %) | | | A-1-1 | A-1-2 | A-1-3 | A-1-4 | A-1-5 | A-1-6 | A-1-7 | A-1-8 |
| Carboxylic | Tetracarboxylic | a-1-1 | 90 | — | — | — | — | 50 | — | — |
| anhydride | dianhydride | a-1-2 | 6 | 65 | — | 40 | 90 | — | 80 | — |
| component | compound | a-1-3 | — | — | 99 | 54 | — | — | — | 60 |
| (a) | (a-1) | | | | | | | | | |
| | Tricarboxylic | a-2-1 | 4 | — | — | — | — | 50 | — | — |
| | anhydride | a-2-2 | — | 5 | 1 | — | — | — | — | 40 |
| | compound | a-2-3 | — | 30 | — | — | — | — | — | — |
| | (a-2) | a-2-4 | — | — | — | 6 | — | — | — | — |
| | | a-2-5 | — | — | — | — | 10 | — | 10 | — |
| | | a-2-6 | — | — | — | — | — | — | 10 | — |
| Diamine | Diamine | b-1-1 | 50 | — | — | — | — | — | — | — |
| component | compound | b-1-2 | — | 5 | — | 1 | — | — | — | 60 |
| (b) | (b-1) | b-1-3 | — | — | 10 | — | — | — | 5 | — |
| | | b-1-4 | — | — | — | — | 3 | — | — | — |
| | | b-1-5 | — | — | — | — | — | 2 | — | — |
| | | b-1-6 | — | — | — | — | — | 2 | — | — |
| | | b-1-7 | — | — | — | — | — | — | — | 20 |
| | Other diamine | b-2-1 | 50 | — | — | 90 | 70 | — | — | — |
| | compounds | b-2-2 | — | 90 | — | — | 27 | 86 | 10 | — |
| | (b-2) | b-2-3 | — | — | 80 | 10 | — | — | 85 | 20 |
| | | b-2-4 | — | 5 | 10 | — | — | 10 | — | — |

| | | | | | | | | |
|---|---|---|---|---|---|---|---|---|
| (a-2)/(b-1) | 0.08 | 7 | 0.1 | 6 | 3.33 | 12.5 | 4 | 0.5 |

| | | | Synthesis example | | | | | |
|---|---|---|---|---|---|---|---|---|
| Component (unit: mole %) | | | A-1-9 | A-1-10 | A-1-11 | A-1-12 | A-2-1 | A-2-2 |
| Carboxylic | Tetracarboxylic | a-1-1 | 80 | 50 | — | — | 90 | 75 |
| anhydride | dianhydride | a-1-2 | — | 20 | 78 | 50 | 6 | — |
| component | compound | a-1-3 | — | — | — | — | — | — |
| (a) | (a-1) | | | | | | | |
| | Tricarboxylic | a-2-1 | 20 | 30 | 11 | — | 4 | — |
| | anhydride | a-2-2 | — | — | 11 | — | — | — |
| | compound | a-2-3 | — | — | — | — | — | 20 |
| | (a-2) | a-2-4 | — | — | — | 50 | — | — |
| | | a-2-5 | — | — | — | — | — | 5 |
| | | a-2-6 | — | — | — | — | — | — |
| Diamine | Diamine | b-1-1 | — | — | 4 | 20 | 50 | — |
| component | compound | b-1-2 | — | 6 | — | 5 | — | — |
| (b) | (b-1) | b-1-3 | — | — | — | — | — | — |
| | | b-1-4 | 2 | — | — | — | — | — |
| | | b-1-5 | — | — | — | — | — | 25 |
| | | b-1-6 | — | — | — | — | — | — |
| | | b-1-7 | — | — | — | — | — | — |
| | Other diamine | b-2-1 | 90 | — | — | — | 50 | 25 |
| | compounds | b-2-2 | — | 90 | — | 85 | — | — |
| | (b-2) | b-2-3 | — | 4 | 90 | — | — | 50 |
| | | b-2-4 | 8 | — | 6 | — | — | — |

| | | | | | | |
|---|---|---|---|---|---|---|
| (a-2)/(b-1) | 10 | 5 | 5.5 | 2 | 0.08 | 1 |

### Comparative Synthesis Example A-3-1 to Comparative Synthesis Example A-3-5

Polymer compositions (A-3-1) to (A-3-5) of comparative synthesis example A-3-1 to comparative synthesis example A-3-5 were respectively prepared with the same steps as synthesis example A-1-1, and the difference thereof is: the type and the usage amount of the raw materials were changed (as shown in Table 2).

TABLE 2

| | | | Comparative synthesis example | | | | |
|---|---|---|---|---|---|---|---|
| Component (unit: mole %) | | | A-3-1 | A-3-2 | A-3-3 | A-3-4 | A-3-5 |
| Carboxylic | Tetracarboxylic | a-1-1 | 90 | — | — | 50 | 75 |
| anhydride | dianhydride | a-1-2 | 10 | 65 | — | — | 25 |
| component | compound | a-1-3 | — | — | 100 | 50 | — |
| (a) | (a-1) | | | | | | |
| | Tricarboxylic | a-2-1 | — | — | — | — | — |
| | anhydride | a-2-2 | — | 5 | — | — | — |
| | compound | a-2-3 | — | 30 | — | — | — |
| | (a-2) | a-2-4 | — | — | — | — | — |
| | | a-2-5 | — | — | — | — | — |
| | | a-2-6 | — | — | — | — | — |
| Diamine | Diamine | b-1-1 | 50 | — | — | — | — |
| component | compound | b-1-2 | — | — | — | — | — |
| (b) | (b-1) | b-1-3 | — | — | — | — | — |
| | | b-1-4 | — | — | — | 117 | — |
| | | b-1-5 | — | — | — | — | 25 |
| | | b-1-6 | — | — | — | — | — |
| | | b-1-7 | — | — | — | — | — |
| | Other diamine | b-2-1 | 50 | — | — | — | 25 |
| | compounds | b-2-2 | — | 95 | — | — | — |
| | (b-2) | b-2-3 | — | — | 90 | — | 50 |
| | | b-2-4 | — | 5 | 10 | — | — |

| | | | | | |
|---|---|---|---|---|---|
| (a-2)/(b-1) | 0 | — | — | 0 | 0 |

### Examples and Comparative Examples of Liquid Crystal Alignment Agent, Liquid Crystal Alignment Film, and Liquid Crystal Display Element

Example 1 to example 15 and comparative example 1 to comparative example 6 of the liquid crystal alignment agent, the liquid crystal alignment film, and the liquid crystal display element are described below:

### Example 1

### a. Liquid Crystal Alignment Agent

100 parts by weight of the polymer composition (A-1-1), 1200 parts by weight of N-methyl-2-pyrrolidone (B-1 hereinafter), and 600 parts by weight of ethylene glycol n-butyl ether (B-2 hereinafter) were weighed. Then, the components were stirred and mixed at room temperature to obtain the liquid crystal alignment agent of example 1.

### b. Liquid Crystal Alignment Film and Liquid Crystal Display Element

The liquid crystal alignment agent of example 1 was coated on a sheet of first glass substrate having a chromium electrode disposed in a pectinate shape with a printing press (made by Nissha Printing Co., Ltd., model: S15-036) to form a pre-coat layer. Then, the first glass substrate was placed on a heating plate and pre-bake was performed at a temperature of 100° C. and a time of 5 minutes. Next, post-bake was performed in a circulation oven at a temperature of 220° C. and a time of 30 minutes. Lastly, after alignment treatment, a first glass substrate in which the liquid crystal alignment film of example 1 was formed on the pectinate-shaped chromium electrode was obtained.

The liquid crystal alignment agent of example 1 was coated on a sheet of second glass substrate without an electrode with a printing press to form a pre-coat layer. Next, after pre-bake, post-bake, and alignment treatment were performed in the same manner as above, a second glass substrate having the liquid crystal alignment film of example 1 formed thereon was obtained. A sealant containing an alumina ball having a diameter of 3.5 μm and an epoxy resin was coated in the periphery of one of the first glass substrate and the second glass substrate, and the first glass substrate and the second glass substrate were laminated in a manner antiparallel to the alignment direction, and then the lamination was performed by applying 10 kg of pressure with a hot press at a temperature of 150° C. Then, injection of liquid crystal was performed with a liquid crystal injection machine (made by Shimadzu Corporation, model: ALIS-100X-CH). Next, the injection port of liquid crystal was sealed with an ultraviolet curing gel, an ultraviolet lamp was used to cure the ultraviolet curing gel by irradiation, and a polarizer was respectively attached to the outside of the two glass substrates, thereby obtaining the IPS-type liquid crystal display element of example 1.

The liquid crystal display element of example 1 was evaluated by each of the following evaluation methods, and the results thereof are as shown in Table 3.

The compounds corresponding to the labels in Table 3 and Table 4 are as shown below.

### ABBREVIATION COMPONENT

B-1N-methyl-2-pyrrolidone (NMP)
B-2 ethylene glycol n-butyl ether
B-3 γ-butyrolactone
C-1 N,N,N′,N′-tetraglycidyl-4,4′-diaminodiphenyl methane
C-2 N,N-glycidyl-p-glycidoxyaniline
C-3 propylene glycol diepoxypropyl ether
D-1 3-aminopropyltrimethoxysilane
D-2 N-phenyl-3-aminopropyltrimethoxysilane
D-3 1,3,5-tricarboxycyclohexane-3,5-anhydride

### Example 2 to Example 15

The liquid crystal alignment agent, the liquid crystal alignment film, and the liquid crystal display element of each of example 2 to example 15 were respectively prepared with the same steps as example 1, and the difference thereof is: the type and the usage amount of the polymer composition (A), the solvent (B), the compound (C) having at least two epoxy groups, and the additive (D) were changed, as shown in Table 3. The liquid crystal display element of each of examples 2 to 15 was evaluated with each evaluation method below, and the results thereof are as shown in Table 3.

### Comparative Example 1 to Comparative Example 6

The liquid crystal alignment agent, the liquid crystal alignment film, and the liquid crystal display element of each of comparative example 1 to comparative example 6 were respectively prepared with the same steps as example 1, and the difference thereof is: the type and the usage amount of the polymer composition (A), the solvent (B), the compound (C) having at least two epoxy groups, and the additive (D) were changed, as shown in Table 4. The liquid crystal display element of each of comparative example 1 to comparative example 6 was evaluated with each evaluation method below, and the results thereof are as shown in Table 4.

### Evaluation Methods

a. Ion Density (ID)

The ion density of the liquid crystal display element of each of example 1 to example 15 and comparative example 1 to comparative example 6 was respectively measured with an electrical measuring machine (made by Toyo Corporation, Model 6254). The test conditions include the application of a voltage of 1.7 V and a triangle wave of 0.01 Hz, and the calculation of peak area of 0 V to 1V in a current-voltage waveform to measure ion density (unit of pC/cm²). A lower ion density (ID) indicates better quality of the liquid crystal display element. The evaluation criteria of ion density are as shown below.

### ⊚: ID<50

### ◯: 50≦ID<100

### Δ: 100≦ID<200

### X: 200≦ID

b. Ultraviolet Reliability

The ultraviolet reliability of the liquid crystal alignment film was evaluated by voltage holding ratio of the liquid crystal display element. More specifically, the measuring method of voltage holding ratio of the liquid crystal display element is as described below.

The voltage holding ratio of the liquid crystal display element of each of example 1 to example 15 and comparative example 1 to comparative example 6 was respectively measured with an electrical measuring machine (made by Toyo Corporation, Model 6254). The test conditions include the application of a voltage of 4 V for 2 ms, release of the voltage, and measurement of the voltage holding ratio (calculated as VHR1) 1667 ms from release. Then, after the liquid crystal display element was irradiated with 4200 mJ/cm² of ultraviolet (model of ultraviolet irradiation machine: KN-SH48K1, made by Kuang Neng), the voltage holding ratio (calculated as VHR2) after ultraviolet irradiation was measured with the same test conditions. Lastly, percentage change of voltage holding ratio (calculated as VHR^{UV} (%)) was obtained by calculating with formula (7). A lower percentage change of voltage holding ratio indicates better ultraviolet reliability.

$${VHR}^{UV} ( \% ) = \frac{VHR 1 - VHR 2}{VHR 1} \times 100 \% \qquad formula ( 7 )$$

The evaluation criteria of percentage change of voltage holding ratio are as shown below.

### ⊚: VHR^{UV}<5%

### ◯: 5%≦VHRUV<10%

### Δ: 10%≦VHR^{UV}<20%

### X: 20%≦VHR^{UV}

TABLE 3

| | | Example | | | | | | | |
|---|---|---|---|---|---|---|---|---|---|
| Component (unit: parts by weight) | | 1 | 2 | 3 | 4 | 5 | 6 | 7 | 8 |
| Polymer composition (A) | A-1-1 | 100 | — | — | — | — | — | — | — |
| | A-1-2 | — | 100 | — | — | — | — | — | — |
| | A-1-3 | — | — | 100 | — | — | — | — | — |
| | A-1-4 | — | — | — | 100 | — | — | — | — |
| | A-1-5 | — | — | — | — | 100 | — | — | — |
| | A-1-6 | — | — | — | — | — | 100 | — | — |
| | A-1-7 | — | — | — | — | — | — | 100 | — |
| | A-1-8 | — | — | — | — | — | — | — | 100 |
| | A-1-9 | — | — | — | — | — | — | — | — |
| | A-1-10 | — | — | — | — | — | — | — | — |
| | A-1-11 | — | — | — | — | — | — | — | — |
| | A-1-12 | — | — | — | — | — | — | — | — |
| | A-2-1 | — | — | — | — | — | — | — | — |
| | A-2-2 | — | — | — | — | — | — | — | — |
| | A-3-1 | — | — | — | — | — | — | — | — |
| | A-3-2 | — | — | — | — | — | — | — | — |
| | A-3-3 | — | — | — | — | — | — | — | — |
| | A-3-4 | — | — | — | — | — | — | — | — |
| | A-3-5 | — | — | — | — | — | — | — | — |
| Solvent (B) | B-1 | 1200 | — | 1000 | — | — | 800 | 900 | 850 |
| | B-2 | 600 | 1600 | — | 750 | 1500 | — | 300 | 850 |
| | B-3 | — | — | 600 | 800 | 100 | 1000 | 300 | — |
| Compound (C) having at | C-1 | — | — | — | 5 | — | — | — | — |
| least | C-2 | — | — | — | — | — | — | — | 3 |
| two epoxy goups | C-3 | — | — | — | — | — | — | — | — |
| Additive (D) | D-1 | — | — | — | — | 3 | — | — | — |
| | D-2 | — | — | — | — | — | — | — | — |
| | D-3 | — | — | — | — | — | — | — | — |
| Evaluation results | Ion density | ◯ | ◯ | ◯ | ⊚ | ◯ | ◯ | ◯ | ⊚ |
| | Ultraviolet | ◯ | ⊚ | ⊚ | ⊚ | ⊚ | ⊚ | ⊚ | ⊚ |
| | reliability | | | | | | | | |

Example

| Component (unit: parts by weight) | | 9 | 10 | 11 | 12 | 13 | 14 | 15 |
|---|---|---|---|---|---|---|---|---|
| Polymer composition (A) | A-1-1 | — | — | — | — | — | — | 50 |
| | A-1-2 | — | — | — | — | — | — | — |
| | A-1-3 | — | — | — | — | — | — | — |
| | A-1-4 | — | — | — | — | — | — | — |
| | A-1-5 | — | — | — | — | — | — | — |
| | A-1-6 | — | — | — | — | — | — | — |
| | A-1-7 | — | — | — | — | — | — | — |
| | A-1-8 | — | — | — | — | — | — | — |
| | A-1-9 | 100 | — | — | — | — | — | — |
| | A-1-10 | — | 100 | — | — | — | — | — |
| | A-1-11 | — | — | 100 | — | — | — | — |
| | A-1-12 | — | — | — | 100 | — | — | — |
| | A-2-1 | — | — | — | — | 100 | — | 50 |
| | A-2-2 | — | — | — | — | — | 100 | — |
| | A-3-1 | — | — | — | — | — | — | — |
| | A-3-2 | — | — | — | — | — | — | — |
| | A-3-3 | — | — | — | — | — | — | — |
| | A-3-4 | — | — | — | — | — | — | — |
| | A-3-5 | — | — | — | — | — | — | — |
| Solvent (B) | B-1 | 1400 | — | 900 | — | — | 1200 | 800 |
| | B-2 | — | 1000 | 900 | 650 | — | 300 | 800 |
| | B-3 | — | 350 | — | 1000 | 1500 | — | — |
| Compound (C) having at | C-1 | — | — | — | — | — | — | — |
| least | C-2 | — | — | — | — | 1 | — | — |
| two epoxy groups | C-3 | — | — | — | — | 2 | — | — |
| Additive (D) | D-1 | — | — | — | — | — | — | — |
| | D-2 | 5 | — | — | — | — | — | — |
| | D-3 | — | — | — | — | — | — | — |
| Evaluation results | Ion density | ◯ | ◯ | ◯ | ◯ | ⊚ | ◯ | ◯ |
| | Ultraviolet | ⊚ | ⊚ | ◯ | ⊚ | ◯ | ⊚ | ◯ |
| | reliability | | | | | | | |

TABLE 4

| Component | | Comparative example | | | | | |
|---|---|---|---|---|---|---|---|
| (unit: parts by weight) | | 1 | 2 | 3 | 4 | 5 | 6 |
| Polymer composition (A) | A-1-1 | — | — | — | — | — | — |
| | A-1-2 | — | — | — | — | — | — |
| | A-1-3 | — | — | — | — | — | — |
| | A-1-4 | — | — | — | — | — | — |
| | A-1-5 | — | — | — | — | — | — |
| | A-1-6 | — | — | — | — | — | — |
| | A-1-7 | — | — | — | — | — | — |
| | A-1-8 | — | — | — | — | — | — |
| | A-1-9 | — | — | — | — | — | — |
| | A-1-10 | — | — | — | — | — | — |
| | A-1-11 | — | — | — | — | — | — |
| | A-1-12 | — | — | — | — | — | — |
| | A-2-1 | — | — | — | — | — | — |
| | A-2-2 | — | — | — | — | — | — |
| | A-3-1 | 100 | — | — | — | — | 100 |
| | A-3-2 | — | 100 | — | — | — | — |
| | A-3-3 | — | — | 100 | — | — | — |
| | A-3-4 | — | — | — | 100 | — | — |
| | A-3-5 | — | — | — | — | 100 | — |
| Solvent (B) | B-1 | 1200 | — | 1000 | 900 | — | 1200 |
| | B-2 | 600 | 1600 | — | 415 | 750 | 600 |
| | B-3 | — | — | 600 | 250 | 800 | — |
| Compound (C) having at | C-1 | — | — | — | — | 5 | — |
| least | C-2 | — | — | — | — | — | — |
| two epoxy groups | C-3 | — | — | — | — | — | — |
| Additive (D) | D-1 | — | — | — | — | — | — |
| | D-2 | — | — | — | — | — | — |
| | D-3 | — | — | — | — | — | 10 |
| Evaluation results | Ion density | ◯ | X | X | ◯ | ⊚ | ◯ |
| | Ultraviolet | X | Δ | X | Δ | X | X |
| | reliability | | | | | | |

### <Evaluation Results>

It can be known from Table 3 and Table 4 that, in comparison to the liquid crystal alignment films (example 1 to example 15) of the liquid crystal alignment agent using the polymer composition (A) containing the tricarboxylic anhydride compound (a-2) and the diamine compound (b-1), the ultraviolet reliability of the liquid crystal alignment films (comparative examples 1, 3, 4, 5, and 6) of the liquid crystal alignment agent without the polymer composition (A) containing the tricarboxylic anhydride compound (a-2) is poor, and the ion density of the liquid crystal display elements (comparative examples 2 and 3) of the liquid crystal alignment agent without the polymer composition (A) containing the diamine compound (b-1) is high. Therefore, the liquid crystal display elements of comparative examples 1, 2, 3, 4, 5, and 6 have significant display defects.

Moreover, when the liquid crystal alignment agent containing the tricarboxylic anhydride compound (a-2) and the diamine compound (b-1) having a molar ratio (a-2)/(b-1) of 0.1 to 5 (examples 3, 5, 7, 8, 10, 12, and 14) is used, the liquid crystal alignment film has better ultraviolet reliability.

Moreover, when the liquid crystal alignment agent containing the compound (C) having at least two epoxy groups (examples 4, 8, and 13) is used, the ion density of the liquid crystal display element is lower, and therefore the display quality of the liquid crystal display element is better.

Based on the above, since the polymer composition included in the liquid crystal alignment agent of the invention contains a tricarboxylic anhydride compound and a specific diamine compound, when applied in a liquid crystal alignment film, the liquid crystal display element has better ultraviolet reliability and lower ion density. Therefore, the liquid crystal alignment agent of the invention is suitable for a liquid crystal alignment film and a liquid crystal display element.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A liquid crystal alignment agent, comprising:
a polymer composition (A); and
a solvent (B),
wherein the polymer composition (A) is obtained by reacting a mixture, and the mixture comprises a carboxylic anhydride component (a) and a diamine component (b),
the carboxylic anhydride component (a) comprises a tetracarboxylic dianhydride compound (a-1) and a tricarboxylic anhydride compound (a-2),
the diamine component (b) comprises a diamine compound (b-1) represented by formula (I), 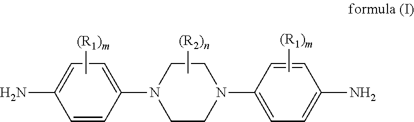
in formula (I),
R₁ each independently represents a hydrogen atom, a C₁ to C₁₀ alkyl group, a C₁ to C₁₀ alkoxy group, an acetamido group, a fluorine atom, a chlorine atom, or a bromine atom;
R² each independently represents a C₁ to C₃ alkyl group;
m each independently represents an integer of 0 to 3;
n represents an integer of 0 to 4.

2. The liquid crystal alignment agent of claim 1, wherein in formula (I), R₁ each independently represents a hydrogen atom, a C₁ to C₁₀ alkyl group, a C₁ to C₁₀ alkoxy group, or an acetamido group.

3. The liquid crystal alignment agent of claim 1, wherein the tricarboxylic anhydride compound (a-2) comprises a cyclic tricarboxylic anhydride compound.

4. The liquid crystal alignment agent of claim 1, wherein based on a total number of moles of 100 moles of the carboxylic anhydride component (a), a usage amount of the tricarboxylic anhydride compound (a-2) is 1 mole to 50 moles.

5. The liquid crystal alignment agent of claim 1, wherein based on a total number of moles of 100 moles of the diamine component (b), a usage amount of the diamine compound (b-1) is 1 mole to 80 moles.

6. The liquid crystal alignment agent of claim 1, wherein a molar ratio (a-2)/(b-1) of the tricarboxylic anhydride compound (a-2) and the diamine compound (b-1) is 0.1 to 5.

7. The liquid crystal alignment agent of claim 1, further comprising a compound (C) having at least two epoxy groups.

8. A liquid crystal alignment film Rained by the liquid crystal alignment agent of claim 1.

9. A liquid crystal display element, comprising the liquid crystal alignment film of claim 8.
